(19) United States
(12) Patent Application Publication
(10) Pub. No.: US 2010/0180744 A1
(43) Pub. Date: Jul. 22, 2010

(54) QUICK CLAMPING ASSEMBLY FOR DRIVING A KNOCKOUT PUNCH

(76) Inventor: WILLIAM F. NORDLIN, POPLAR GROVE, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/356,223

(22) Filed: Jan. 20, 2009

(51) Int. Cl. B26F 1/14; B26F 1/00

(52) U.S. Cl. 83/686; 30/360

(57) ABSTRACT

A clamping assembly for driving a knockout punch is provided. The clamping assembly has an outer member, an inner member, and wedges that are guided by keyways on the inner member. A user pushes onto the inner member, which causes the wedges to contact a cam surface on the outer member, which forces the wedges in a radial inward direction until threads provided on said wedges clamp onto complimentary shaped threads on a draw stud.

### FIELD OF THE INVENTION

This invention is generally directed to a clamping assembly for use with a knockout punch.

### BACKGROUND OF THE INVENTION

Knockout punches are used routinely to create holes in thin layers of material such as the sheet metal found on electrical boxes. Knockout punches are used in conjunction with a draw stud, a ram, and a die which are all used to punch a hole.

The user drills a pilot hole approximately in the center of the area where the final hole needs to be located. The draw stud, which has been attached to the ram, has the die slid over its free end until the die abuts the ram. The draw stud is then inserted with its free end first through the pilot hole until the die is seated against on one side of a sheet of material. The knockout punch, which has a central hole with internal threads, is screwed onto the free end of the draw stud which has complimentary-shaped external threads on it. This process continues until the knockout punch impinges onto the side of the sheet of material opposite the side on which the die is located. As a result, the sheet of material is snugly captured on both sides by the die and punch. Finally, the ram is actuated such that the draw stud and knockout punch are drawn toward the ram, supplying sufficient force to the knockout punch to puncture and cut the sheet of material and produce the final hole.

The ram that is used is usually mechanically or hydraulically powered, but can be powered by other means. Overall, this device works well, however, the most time consuming task is screwing the knockout punch onto the draw stud, which can take as long as thirty to sixty seconds to accomplish depending on the length of the draw stud. Of course, this can be frustrating and inefficient for the user, especially when a great number of holes need to be punched. Accordingly, there has been a need to find a way to couple the knockout punch to the draw stud in a faster manner.

One device that has been proposed to satisfy this need is shown in FIGS. 1-4. The device 20 is a quick clamping, cam-actuated device, and that can be clamped onto a specially-made draw stud 22. The draw stud 22 has a first end with standard threads 24 thereon so that the draw stud 22 can be attached to an associated ram (not shown). The other end of the draw stud 22 is passed through a die 26 and a pilot hole 28 in a sheet of material 30, and then through a punch 32 and the device 20. The other end of the draw stud 22 has a series of straight grooves 34 thereon that are configured so that the device 20 can clamp thereon. The device 20 has a central opening 36 therethrough that is larger than the diameter of the draw stud 22 so that the device 20 can fit over the draw stud 22 and slide easily relative to the draw stud 22.

The device 20 is formed from an outer member 38 that forms the majority of the exposed circumferential surface, an inner member 40 that fits inside the outer member 38 and is substantially unexposed, three identically configured wedges 42 that are between the outer and inner members 38, 40, a first set of three springs 44 with each spring 44 trapped between two wedges 42, a brass washer 46 that is located on the bottom surface of the wedges 42, and a second set of three springs 48 that extend from apertures found on the top surface of the inner member 40 and that press onto the bottom of the washer 46. Finally, three apertures 50 with ball bearings 52 are found on the periphery of the outer member 40. These ball bearings 52 are forced downward by an O-ring 56 that is found in a groove that overlays these apertures 50. The O-ring 56 forces the ball bearings 52 into a cavity 54 found on the periphery of the inner member 40 such that the ball bearings 52 engage the outer member 38 and extend into this cavity 54. Consequently, the inner member 40 can slide relative to the outer member 38 until the ball bearings 52 contact the opposing walls of the cavity 54 preventing disassembly of the device 20.

As can be seen more clearly in FIG. 4, the outer member 40 has an inner conical cam surface 60 located at one end that is complimentary to outer cam surfaces 62 on the wedges 42. The user actuates the device 20 by pushing on the inner member 40, which, in turn, starts to compress the second set of springs 48 which push against the washer 46. This provides the necessary force to push the wedges 42 forward so that their outer cam surfaces 62 engage the inner cam surface 60 of the outer member 38, which, in turn, causes the wedges 42 to move in an inwardly radial direction. This movement continues until internal grooves 62 on the concave surfaces of the wedges 42 mate with the external grooves 34 on the draw stud 22, locking the device 20 in place so that any linear movement of the draw stud 22 is necessarily transferred to the punch 32 caught between the sheet of material 30 and the device 20.

During this clamping process, each spring 44 which is trapped in the side holes of the wedges 42 is compressed, allowing the wedges 42 to clamp onto the draw stud 22. To unclamp the device 20 from the draw stud 22, the user pulls onto the rear of the inner member 40 which allows the second set of springs 48 to relax, which, in turn, allows the stored-up energy in the first set of springs 44 to be released, causing the first set of springs 44 to expand which causes the wedges 42 to retreat and move in an outwardly radial direction until the internal grooves 62 on the wedges 42 no longer mate with the external grooves 34 on the draw stud 22. Then, the user can slide the device 20 and the punch 32 off the draw stud 22 in order to get ready to punch another hole in another location.

The purpose of the first set of springs 44 is presumably to help make sure that any wedge 42 that happens to be found on the top of the draw stud 22 will disengage from the grooves 34 on the draw stud 22 when the user pulls back on the inner member 40. Absent this force for biasing the disengagement, the wedge 42 will tend to remain engaged with the draw stud 22 due to gravity. This, in turn, makes it difficult for the user to slide the device 20 off of the draw stud 22, resulting in user frustration.

However in practice, this device 20 has too many parts which make assembly difficult. For example, the three ball bearings 52 used to lock the outer member 38 and the inner member 40 together are located at a one hundred twenty degree angle from each other, which means at least one ball bearing 52 is facing downward and tends to fall out of its respective aperture due to gravity when trying to seat the O-ring 56 into its groove on the outer member 38. Likewise, it is difficult to hold all six springs 44, 48 in place when assembling the device 20. In addition, the great number of components, especially springs 44, 48, adds unwanted cost to the device 20. Fourth, the device 20 works only in conjunction with specially-made draw studs 22 that have straight grooves 34 at the free end and does not work with many draw studs 22 in the field that are threaded at this free end. This makes the device 20 inconvenient for use with many prior art draw studs, which also adds cost to the overall assembly.

Accordingly, there still exists a need for a quick clamping device for driving a knockout punch that is more reliable, more cost effective, easier to assemble, and is more compatible with existing draw studs in the field then any other device that is currently available.

### SUMMARY OF THE INVENTION

Briefly, the present invention provides a clamping assembly for driving a knockout punch. The clamping assembly has an outer member, an inner member, and wedges that are guided by keyways on the inner member. A user pushes onto the inner member, which causes the wedges to contact a cam surface on the outer member, which forces the wedges in a radial inward direction until threads provided on said wedges clamp onto complimentary shaped threads on a draw stud.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is an exploded perspective view of a clamping assembly, a punch, a workpiece, a die and a draw stud which is formed in accordance with the prior art;

FIG. 2 is an exploded perspective view of the clamping assembly of FIG. 1;

FIG. 3 is an exploded side elevational view of the clamping assembly of FIG. 1;

FIG. 4 is an exploded cross-sectional view of the clamping assembly of FIG. 1;

FIG. 5 is a perspective view of a clamping assembly which incorporates features of the present invention, a punch, a die and a draw stud;

FIG. 6 is a perspective view of the punch, the die and the draw stud assembled together, and an exploded perspective view of the clamping assembly of FIG. 5;

FIG. 7 is a perspective view of an outer member which is a component of the clamping assembly shown in FIG. 5;

FIG. 8 is a cross-sectional view of the outer member;

FIG. 9 is a perspective view of an inner member which is a component of the clamping assembly shown in FIG. 5;

FIG. 10 is an end plan view of the inner member;

FIG. 11 is a cross-sectional view of the inner member along line 11-11 of FIG. 10;

FIG. 12 is a side elevational view of the inner member;

FIG. 13 is another side elevational view of the inner member;

FIG. 14 is a perspective view of a wedge which is a component of the clamping assembly shown in FIG. 5;

FIG. 15 is another perspective view of the wedge;

FIG. 16 is a top elevational view of the wedge;

FIG. 17 is an end plan view of the wedge;

FIG. 18 is a side elevational view of the wedge;

FIG. 19 is a cross-sectional view of the wedge; and

FIG. 20 is a cross-sectional view of the clamping assembly assembled onto the draw stud with the punch and die.

### DETAILED DESCRIPTION OF THE PREFERRED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

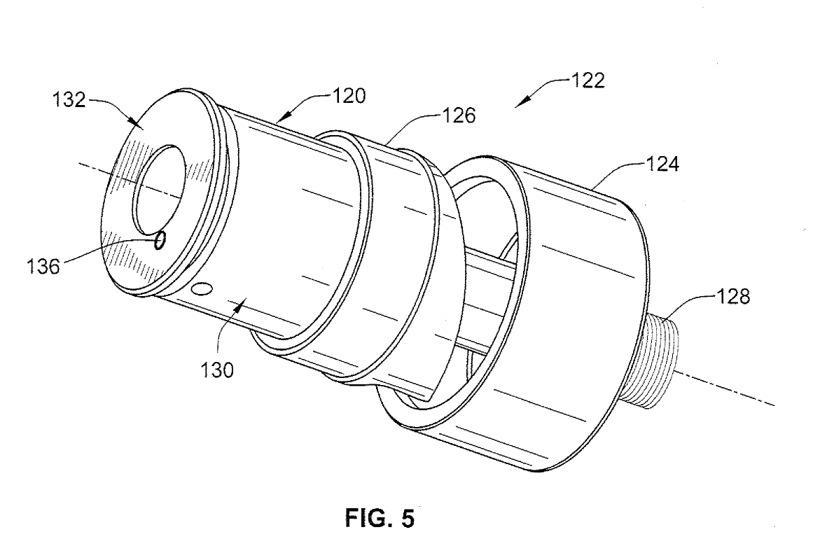

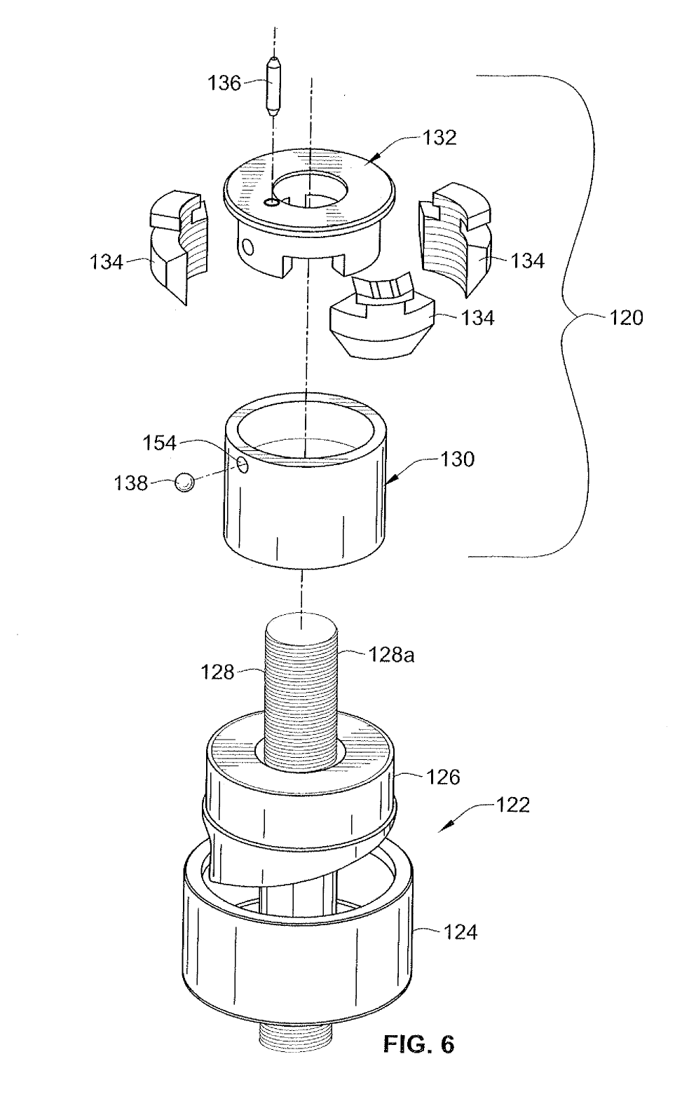

FIGS. 5 and 6 show a preferred embodiment of a clamping device 120 for driving a knockout punch 122 in accordance with the present invention. The knockout punch 122 is standard and includes a die 124, a punch 126 and a standard draw stud 128, each of which is readily available in the field, and therefore, are not described herein.

The clamping device 120 includes an outer member 130, an inner member 132, wedges 134 that are trapped in between the outer and inner members 130, 132, and a pin 136 and a ball 138 for locking the outer and inner member 130, 132 together. The pin 136 may take the form of a roll pin.

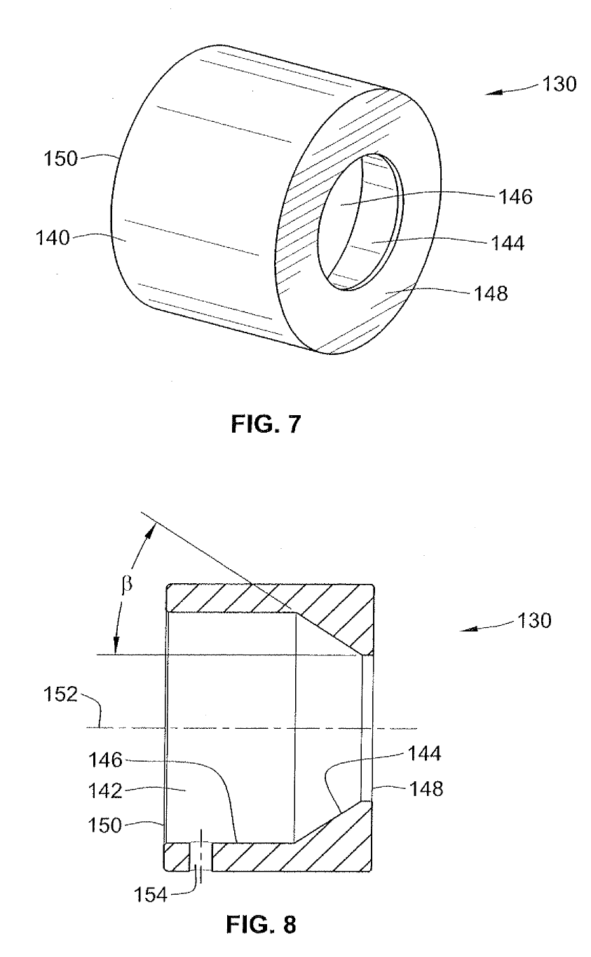

As shown in FIGS. 7 and 8, the outer member 130 is defined by a wall 140 which has a central passageway 142 provided therethrough. An exterior surface of the wall 140 is preferably cylindrical. The central passageway 142 is defined by an interior surface which includes a first portion 144 and a second portion 146. The first portion 144 extends from a first end 148 of the outer member 130 forwardly a predetermined distance. The second portion 146 extends from the opposite end of the first portion 144 to the second end 150 of the outer member 130. The second portion 146 has a constant diameter and is preferably cylindrical. The first portion 144 tapers from the second portion 146 inwardly to the first end 148 of the outer member 130. As a result, the passageway 142 at the first end 148 is smaller than the passageway 142 at the second end 150. The passageway 142 at the first end 148 allows the draw stud 128 to slide therethrough without difficulty. The passageway 142 at the second end 150 receives the inner member 132 into the passageway 142. The first portion 144 of the passageway 142 provides a conical cam surface that makes a thirty degree angle with respect a centerline 152 of the outer member 130, shown by reference β. An aperture 154 is provided through the outer member 130 proximate to the second end 150 such that the aperture 154 is in communication with the second portion 146 of the passageway 142.

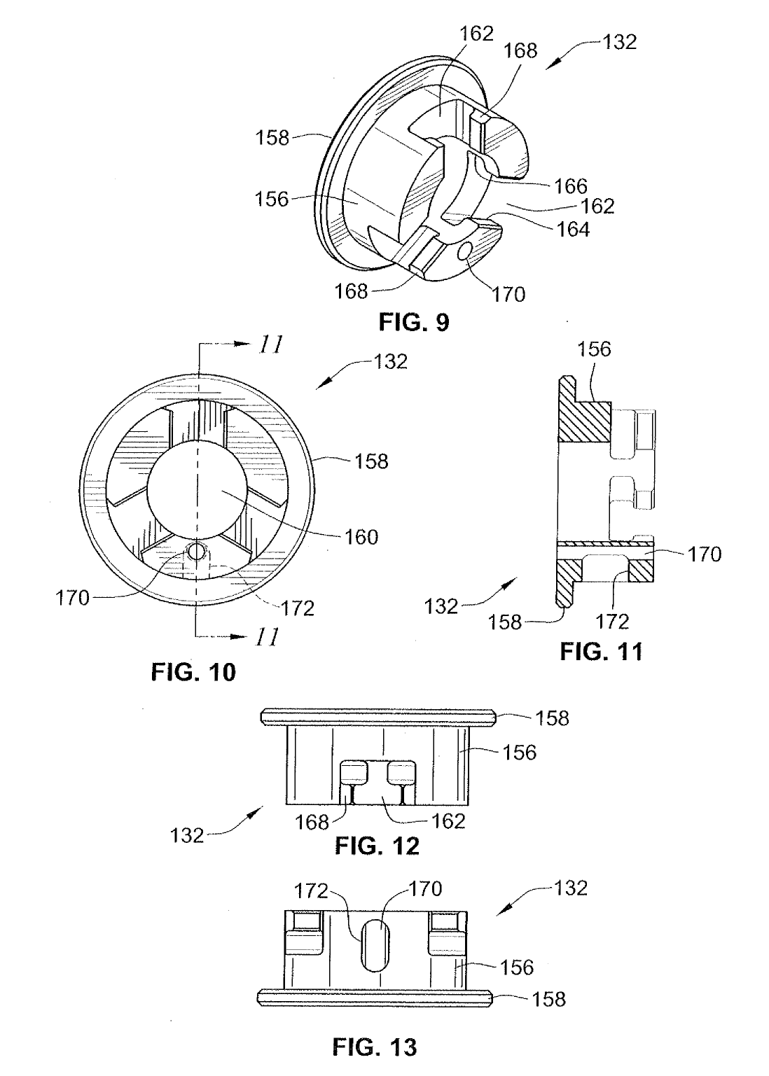

As shown in FIGS. 9-13, the inner member 132 has a main body 156 and a lip 158, each of which are preferably cylindrical. The main body 156 has a diameter which is smaller than the diameter of the lip 158. The main body 156 has an outer diameter that is slightly smaller than the diameter of the second portion 146 of the passageway 142 such that the main body can be inserted into the second portion 146 of the passageway 142.

A passageway 160 is provided through the inner member 132 and extends from a first end to a second end. The passageway 160 has a diameter which is generally the same size as the passageway 142 at the first end 148 of the outer member 130 so that the draw stud 128 can fit through the inner member 132 without difficulty.

The main body 156 has a plurality of keyways 162 of identical configuration provided therein. The keyways 162 are in communication with the passageway 160 and pass completely through the main body 156 from its outer circumferential surface to its inner diameter. As shown, three such keyways 156 are provided and are spaced one hundred twenty degrees from each other around the circumference of the main body 156. As shown, each keyway 162 is preferably T-shaped and includes a first section 164 which extends from the first end of the main body 156 towards the second end of the main body 156 and is parallel to a central axis of the inner member 132, and a second section 166 provided at the second end of the first section 164 and which is perpendicular to the central axis. Chamfers 168 are provided on the main body 156 proximate to the first section 164 such that the wall forming each chamfer 168 angles from the outer circumference of the main body 156 toward the passageway 160. The chamfers 168 ease placement of the wedges 134 into the keyways 162 as described herein.

The lip 158 extends around the circumference of the main body 156 and protrudes far enough from the exterior surface of the main body 156 such that the lip 158 extends outwardly from the outer member 130 when the clamping assembly 120 is assembled as described herein. The lip 158 allows for a user to easily grip the lip 158 to cause the inner member 132 to slide away from the outer member 130.

A bore 170 extends from the first end of the inner member 132 to the second end such that the bore 170 is parallel to the central axis of the inner member 132. The bore 170 is radially spaced from the central passageway 160 and is spaced between two of the keyways. An elongated slot 172 is provided in the main body 156 and extends from its outer circumference to the bore 170 such that the elongated slot 172 is in communication with the bore 170.

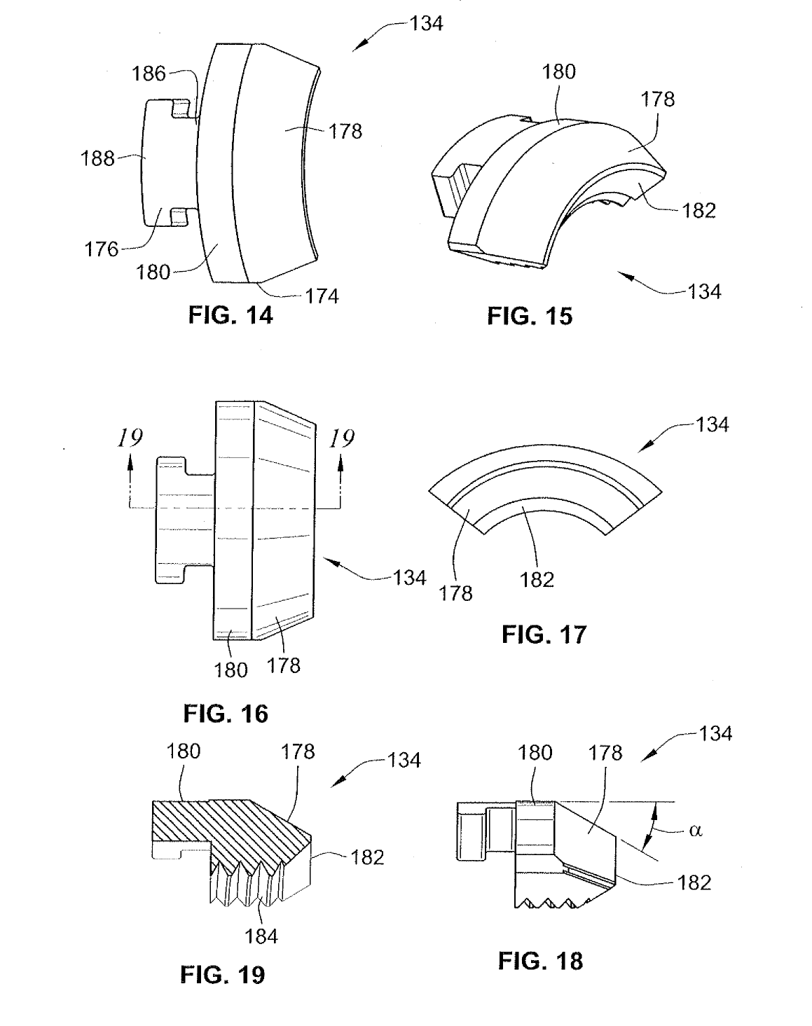

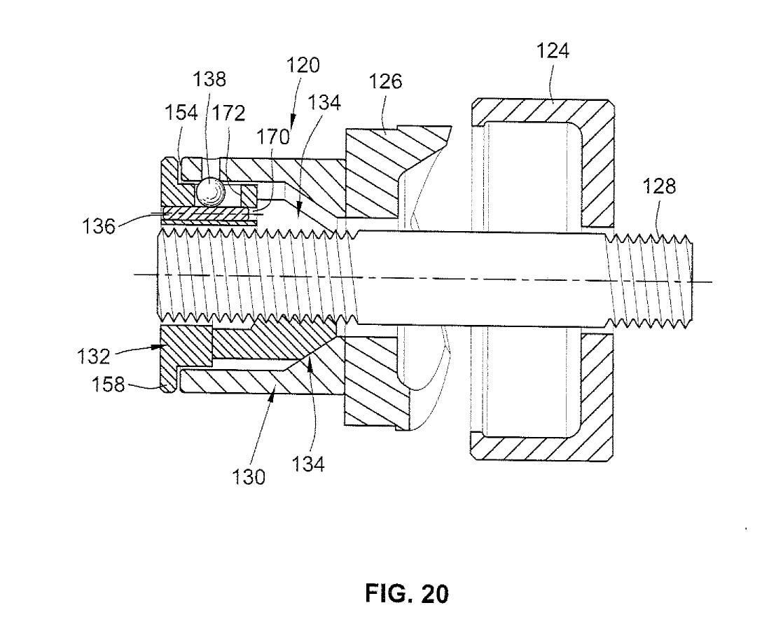

Each wedge 134 is identically formed and therefore, only a single wedge 134 is described and shown in FIGS. 14-19 for ease in explanation. The wedge 134 has an engaging portion 174 and a key 176 extending from a rear end of the engaging portion 174. The inner and outer surfaces of the wedge 134 are arcuate as shown in FIG. 17.

The engaging portion 174 includes a first section 178 and a second section 180. The first section 178 extends a predetermined distance rearwardly from a front end 182. The second section 180 extends from the rear end of the first section 178 to the key 176. The outer surface of the first section 178 is angled (α) at a thirty degree angle relative to the central axis of the wedge 134. The front end 182 is generally perpendicular to the central axis of the wedge 134. The outer surface of the first section 178 forms a cam surface. The outer surfaces of the first sections 178 form a cylinder when the wedges 134 are seated against the second portion 146 of the inner member 132. The engaging portion 174 of each wedge 134 is sized to occupy a one hundred twenty degree sector, such that when the three wedges 134 are abutted against each other, the wedges 134 form a circle.

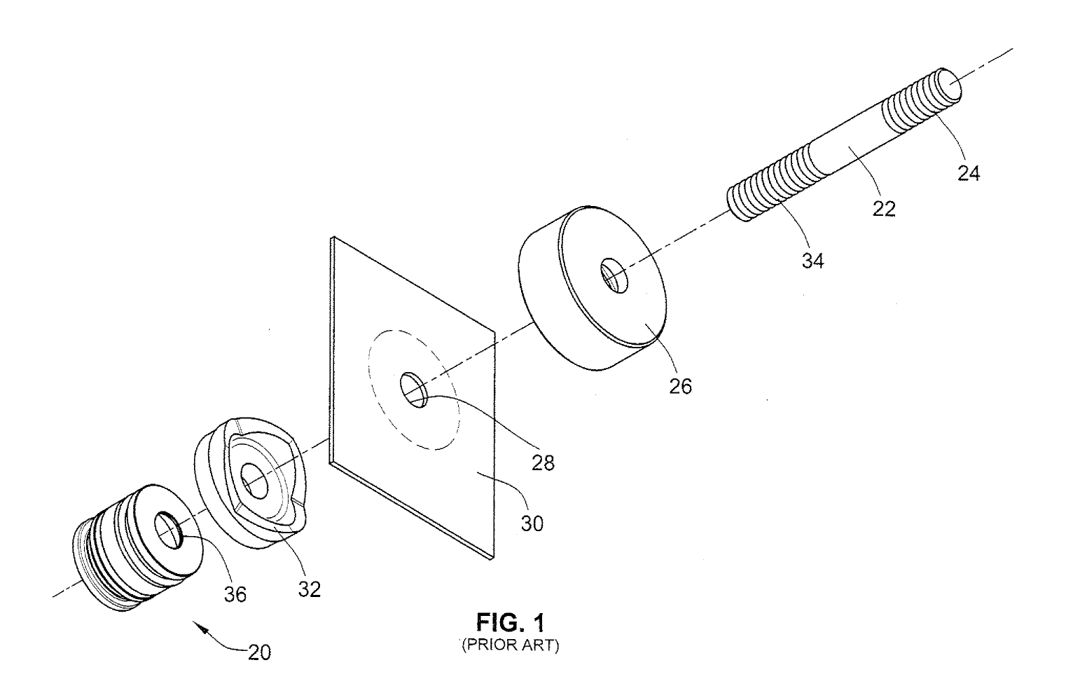

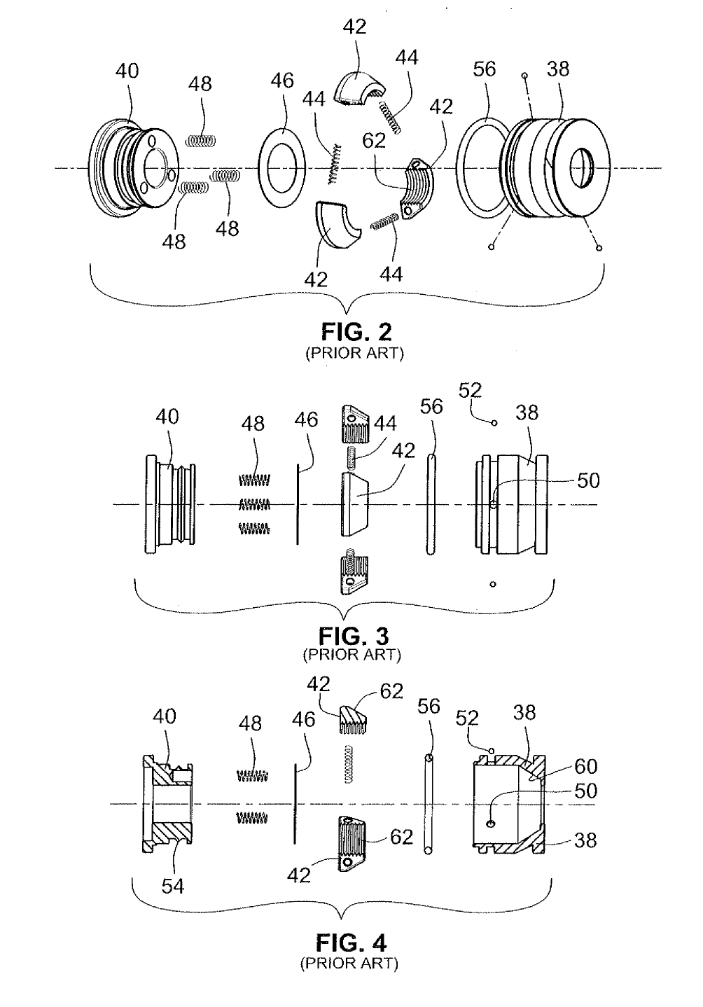

The interior surface of the engaging portion 174 has a plurality of threads 184 thereon as best shown in FIG. 19. The thread 184 on the wedges 134 are configured so that when clamping assembly 120 is activated as discussed herein, the threads 184 of one wedge 134 transitions seamlessly with the threads 184 of the adjacent wedge 134 so that wedges 134 will effectively clamp onto the external threads 128a of the draw stud 128 as described herein. In other words, each wedge 134 has threads 184 that are one hundred twenty degrees in advance of the preceding wedge 134 as viewed in a clockwise direction from the free end of the draw stud 128. Furthermore, there is no compression between the wedges 134 and the draw stud 128 as is suggested by the device shown in FIGS. 1-4, but instead there is a slight clearance present that is typically associated between the external threads of a stud and the internal threads of a nut.

The key 176 corresponds in shape to the keyway 162. As shown, the key 176 is T-shaped and includes a first section 186 which extends from the rear end of the engaging portion 174 and is parallel to the central axis of the inner member 132, and a second section 188 provided at the rearmost end of the first section 186 and which is perpendicular to the central axis of the inner member 132. The key 176 is configured to fit relatively snugly within the respective keyway 162 of the inner member 132 and can slide therein with approximately ten thousandths of an inch clearance between the wedges 134 and the inner member 132. This prevents unwanted binding as the wedges 134 slide relative to the inner member 132 as discussed herein. While the keyways 162 and keys 176 are shown as T-shaped, it is to be understood that other shapes may be used provided the wedge 134 cannot be slid forwardly out of engagement with the inner member 132. The key 176 is recessed from the threads 184 on the engaging portion 174 so that there is clearance between the key 176 and any draw stud 128 passing through the outer and inner members 130, 132 as the draw stud 128 slides back and forth with respect to the inner member 132.

The ball 138 has a diameter which is slightly smaller than the width of the elongated slot 172. When the ball 138 is inserted into the elongated slot 172, the ball 138 enters into the bore 172, but cannot pass through the bore 172. When the ball 138 enters into the bore 172, the ball 138 sits below the surface of the main body 156.

The components of the clamping assembly 120 are manufactured as follows. All the components are made from a medium carbon alloy steel that can be heat treated to create a hardness ranging from forty-five to fifty-five Rockwell scale C. The outer member 130 is turned while the aperture 154 is drilled. The inner member 132 is made using an investment casting process that allows all of its features to be made in one operation. Only the passageway 170 is drilled in a secondary operation. The wedges 134 are made using a powdered metal or metal injection molding process that allows all of its features including the threads 184 to be made in a single operation by orientating the cavity that forms the wedge 134 on its side so the threads 184 can be released using a straight pull. A single cavity with three inserts can be employed to make the wedges 134 with the three necessary thread profiles in order to minimize tooling costs. The ball 138 and pin 136 that are used in assembly can be readily purchased.

The clamping assembly 120 is assembled in the following manner. First, the assembler places the inner member 132 with its second end (the end at the lip 158) on a flat surface. Next, the wedges 134 are each placed such that each key 176 fits within a keyway 162 of the inner member 132 and their internal threads 184 face the central passageway 160 of the inner member 132. The assembler must ensure that the timing of the wedges 134 is proper as their threads 184 are not identical and will not align otherwise. Accordingly, it is desirable to have each wedge 134 marked with a letter or number so that their proper placement with respect to each other can be maintained. Alternatively, the keyways 162 on the inner member 132 can be different from each other, but shaped to conform to like-shaped keys on the wedges 134 to ensure correct orientation (this, of course, would require three different molds to manufacture the wedges 134).

Next, the ball 138 is inserted into the elongated slot 172 from the end of the inner member 132. The ball 138 enters into the bore 172, but is also maintained within the slot 172.

The assembler places the outer member 130 over the inner member 132, the wedges 134 and the ball 132. The first section 178 which forms a cam surface on each wedge 134 engages with the first portion 144 which forms a cam surface in the outer member 130. The exterior surface of the second portion 180 of the wedges 134 engages with the second portion 146 of the passageway 142. The outer surface of the main body 156 of the inner member 132 also engages with the second portion 146 of the passageway 142.

The assembler then rotates and slides the outer member 130 relative to the inner member 132 and wedges 134 until the aperture 154 on its circumference aligns with the elongated slot 172 and the aperture 154 overlays the ball 138. Finally, the assembler inserts the pin 136 into the bore 170 through the rear end of the inner member 132, which forces the ball 138 partially into the aperture 154 of the outer member 130 and joins the outer and inner members 130, 132 together, while still allowing the inner member 132 to slide relative to the outer member 130. Now the ball 138 is trapped in the aperture 154 and will periodically contact either end of the elongated slot 172 as the inner member 132 slides relative to the outer member 130, preventing the clamping assembly 120 from disassembling. Finally, the pin 136 is hammered until it is flush with the end face of the inner member 132, thereby rendering disassembly difficult as the clamping assembly 20 is not meant to be serviceable. Other known means for attaching the outer and inner members 130, 132, while still allowing the outer and inner members 130, 132 to slide relative to each other are within the scope of the present invention.

The clamping assembly 120 can be placed in an unlocked state or a locked state. To place the clamping assembly 120 in the unlocked state, the assembler grasps the lip 158 and pulls the inner member 132 outwardly relative to the outer member 130, which, in turn, causes the wedges 134 to slide relative to the outer member 130. The first sections 178 which form cam surfaces of the wedges 134 disengage from the first portion 144 which form cam surfaces on the outer member 130, thereby allowing the keys 176 of the wedges 134 to slide outwardly in the keyways 162, thereby spreading the wedges 134 apart from each other. The ball 138 slides along the elongated slot 172, but cannot pass beyond the rear end of the elongated slot 172, thereby preventing the disengagement of the inner member 132 from the outer member 130. If the draw stud 128 is inserted therein, the wedges 134 would not engage the threads 128a of the draw stud 128. To place the clamping assembly 120 in the locked state, the assembler grasps the lip 158 and pushes the inner member 132 inwardly into the outer member 130, which, in turn, causes the wedges 134 to slide relative to the outer member 130. The first sections 178 which form cam surfaces of the wedges 134 engage with first portion 144 which form the cam surface on the outer member 130, thereby causing the keys 176 of the wedges 134 to slide inwardly in the keyways 162, thereby moving the wedges 134 toward each other. The ball 138 slides along the elongated slot 172, but cannot pass beyond the front end of the elongated slot 172, thereby preventing the disengagement of the inner member 132 from the outer member 130. If the draw stud 128 is inserted therein, the wedges 134 engage the threads 128a of the draw stud 128.

Once assembled, the clamping assembly 120 can be used with the draw stud 128 in the following way. First, the user drills a pilot hole 28 in a workpiece 30, see FIG. 1 which shows the workpiece 30 and the pilot hole 28. The draw stud 128 is threaded into an associated ram (not shown.) The draw stud 128 is passed the die 124, then the draw stud 128 is passed through the pilot hole 28 to prepare for punching a hole. Second, the punch 126 is inserted over the draw stud 128 and is slid until it impinges on the workpiece 30. Third, the clamping assembly 120 which is in an unlocked state is slid over the draw stud 128 and the draw stud 128 extends through the passageways 142, 160 of the outer and inner members 130, 132 until the outer member 130 contacts the punch 126. Fourth, the user pushes gently on lip 158 of the inner member 132 which causes the inner member 132 to thrust the wedges 134 forward until the first sections 178 which form cam surfaces on the wedges 134 engage the first portion 144 which form cam surface of the outer member 130 which forces the wedges 134 to move in an inward radial direction. Eventually, the threads 184 of the wedges 134 lightly engage the threads 128a of the draw stud 128.

It is sometimes desirable to spin the inner member 132 a half or a third of a turn in the tightening direction of the threads 184 after pushing onto the inner member 132 to effectively lock the clamping assembly 120 onto the draw stud 128. This draws the punch 126 and die 124 tightly against the workpiece 30, allowing the hole 28 to be punched in a precise location. Finally, the user actuates the ram which causes the draw stud 128, clamping assembly 120 and knockout punch 122 to engage the workpiece 30 and create a final hole.

Once the hole has been created, the user can unlock the clamping assembly 120 by twisting the clamping assembly 120 a quarter of a turn in the loosening direction and by pulling on the lip 158 of the inner member 132 which causes the inner member 132 to slide away from the outer member 130. Gravity will then allow at least two of the wedges 134 to release from the draw stud 128 and move in a radial outward direction. However, one of the wedges 134 may stay loosely engaged with the draw stud 128 if the wedge 134 is on the top half of the draw stud 128 due to gravity and the lack of any force biasing the wedge 134 away from the draw stud 128. In such a situation, the user simply has to rattle the clamping assembly 120 slightly and pull until the last wedge 134 releases from the draw stud 128 and continue to pull until the clamping assembly 120 has slid off the draw stud 128 completely.

For the preferred embodiment, a draw stud 128 having ¾-16″ external threads 128a on its free end can be used which is inserted through a seven eighths of an inch diameter pilot hole. It may be necessary to provide a longer draw stud 128 to accommodate the length of the clamping assembly 120. The punch 126 lacks any internal threads in its central hole which has a 0.753″-0.750″ diameter so that the punch 126 can slide along the draw stud 128 easily while still being able to be closely guided by the draw stud 128 during the punching process. Finally, the components of the clamping assembly 120 are configured so that a mere eighth of an inch movement of the inner member 132 in the axial direction effectuates the locking and unlocking of the clamping assembly 120.

The clamping assembly 20 is free from any elastically deformable members including rubber elements or springs which ease installation and reduce costs. Also, there may be no force biasing a wedge to disengage from a draw stud. Therefore, this clamping device 120 is more effective, has fewer parts, is less costly, is easier to assembly, and that works with standard draw studs found in the field. Of course, those with ordinary skill in the art will be able to make modifications to this preferred embodiment without departing from the spirit and scope of the present invention. For example, it is possible to use different key configurations on the inner member 132 such as keyhole and dovetail shapes. Likewise, straight grooves could be employed instead of angled threads on the wedges 134 and the draw stud 128. It is also contemplated that other sizes, thread types, dimensions, clearances and configurations could be employed without departing from the spirit and scope of the present invention. Therefore, the scope of this invention should not be limited to the preferred embodiment but should be interpreted in view of the attached claims.

While a preferred embodiment of the present invention is shown and described, it is envisioned that those skilled in the art may devise various modifications of the present invention without departing from the spirit and scope of the appended claims.

What is claimed is:

1. A quick clamping assembly comprising:
an outer member having an internal cam surface;
an inner member that is movably attached to said outer member and fits within said outer member, said inner member having at least two keyways;
a draw stud having threads thereon; and
a plurality of wedges, each said wedge having a cam surface that is complimentary to the cam surface of the outer member and engaging therewith and a gripping area for engaging the threads on said stud, each said wedges having a key that engages within a respective keyway of the inner member, wherein said inner member can be moved relative to said outer member into a locked configuration such that said wedges move toward each other, and said inner member can be moved relative to said outer member into an unlocked configuration such that said wedges move away from each other.

2. The quick clamping assembly of claim 1, wherein the keyways in the inner member have a T-shaped configuration and the wedges have T-shaped keys.

3. The quick clamping assembly of claim 1, wherein said draw stud has a standard external thread configuration and the gripping area on said wedges have a standard internal thread configuration that are of the same size and type as the external threads of the draw stud.

4. The quick clamping assembly of claim 1, wherein said inner member fits almost entirely within said outer member when in a locked configuration, said inner member further comprising a lip that extends outwardly from the outer member.

5. The quick clamping assembly of claim 1, wherein said inner member further comprises chamfers proximate to said keyways.

6. The quick clamping assembly of claim 1, further including a slot having a predetermined length provided in said inner member, an aperture on said outer member, and a ball within said slot and aperture, said ball being capable of moving along the length of said slot as said inner member moves relative to said outer member.

7. The quick clamping assembly of claim 1, further including a bore in said inner member, said bore in communication with said slot, and a pin inserted into said bore, said pin engaging said ball.

8. An assembly comprising:
an outer member having a central axis, an aperture provided in said outer member which generally perpendicular to said central axis;
an inner member having a central axis, said inner member capable of sliding movement relative to said outer member in a direction along said central axis, said inner member having an end face, a bore extending from said end face along a direction parallel to said central axis, a slot having a predetermined length, said slot being parallel to said central axis of said inner member and in communication with said bore; and
a plurality of wedges positioned between the inner and outer members;

9. The assembly of claim 8, further comprising a ball positioned within said aperture and which partially extends into said slot, and a pin positioned in said bore, said pin engaging said ball causing said ball to engage said outer member while still protruding into said slot.

10. The assembly of claim 9, wherein said pin is a roll pin.

11. A method of punching a hole in a sheet of material, comprising:
creating a pilot hole in a workpiece;
providing a draw stud, a die, a punch and a clamping assembly;
sliding the die over the draw stud;
inserting a free end of the draw stud through the pilot hole until the die contacts the workpiece;
sliding the punch onto the draw stud until the punch touches the workpiece;
sliding the clamping assembly onto the draw stud until the clamping assembly contacts the punch;
locking the clamping assembly onto the draw stud; and
pulling the draw stud, clamping assembly and punch toward the workpiece until a hole is punched.

12. The method of claim 11, further comprising rotating a portion of the clamping assembly slightly so that the clamping assembly grips the draw stud.

13. The method of claim 12, further comprising unlocking the clamping assembly and sliding the punch and clamping assembly off of the draw stud.
